(19) United States
(12) Patent Application Publication
(10) Pub. No.: US 2025/0022671 A1
(43) Pub. Date: Jan. 16, 2025

(54) SWITCH DEVICE FOR VEHICLE

(71) Applicant: LS AUTOMOTIVE TECHNOLOGIES CO., LTD., Anyang-si, Gyeonggi-do (KR)

(72) Inventor: Young Min RYU, Incheon (KR)

(73) Assignee: LS AUTOMOTIVE TECHNOLOGIES CO., LTD., Anyang-si, Gyeonggi-do (KR)

(21) Appl. No.: 18/712,968

(22) PCT Filed: Nov. 22, 2022
(86) PCT No.: PCT/KR2022/018486

§ 371 Date: May 23, 2024

(30) Foreign Application Priority Data
Nov. 23, 2021 (KR) 10-2021-0161883

(51) Int. Cl. H01H 13/02; H01H 13/14

(52) U.S. Cl. CPC H01H 13/023; H01H 13/14

(57) ABSTRACT

The present invention provides a switch device (10) for a vehicle, the switch device (10) being characterized by comprising: a switch housing (100) fixedly disposed in the vehicle; a switch knob (200) disposed in the switch housing (100) so as to be operable by a user and having knob icons (201, 202) on one side; a switch unit (300) which is operated by the user's manipulation of the switch knob (200) and generates a changed electrical signal; and a light source unit (500) which is disposed in the switch housing (100) and outputs and transmits generated light to the switch knob (200) side, wherein the light source unit (500) includes a plurality of knob icon light sources (510, 510a, 510b) capable of simultaneously emitting light to one of the knob icons (201, 202), and at least a portion of the switch knob (200) includes a light control region unit (230) in which the thickness between the inside of the switch knob (200) and the outer surface of the switch knob (200) is different.

### TECHNICAL FIELD

The present invention relates to a switch device for a vehicle, and more particularly, to such a switch device for a vehicle, which can ensure uniformity of light irradiation.

### BACKGROUND ART

In general, a steering wheel assembly for a vehicle includes a steering wheel, a steering column, a steering roll connector assembly, and a multi-functional switch assembly. The steering wheel is intended to allow a driver to set the steering direction. The rotation of the steering wheel by the driver is transferred to vehicle wheels through the steering column so that the steering angle of the vehicle is set. In addition, a vehicle such as an automobile requires functions of various kinds of convenience means for offering a more stable and comfortable driving state for the driver, beyond a function of the vehicle as a means of transportation. Accordingly, the vehicle is equipped with various convenient facilities and a variety of switches for operating and controlling the facilities, and various switches tend to be concentrated on the steering wheel in consideration of the manipulability of the driver.

For example, the steering wheel of a vehicle which is recently produced includes a window switch for opening or closing a window, a steering light switch for turning on or off a steering light, an audio switch for driving an audio device, and a wiper switch for driving a wiper.

The multi-functional switch assembly includes a light and a fog lamp, a wiper, a variety of audio devices, and a vehicle window switch, and the like. The multi-functional switch assembly serves to prevent the driver's driving attention from being dissipated even during manipulation of a wide variety of devices by increasing the manipulability of the various devices. The multi-functional switch assembly is implemented as a button switch mounted on a top of the steering wheel, or a vehicular switch mounted on a side of the steering wheel.

The switch for a vehicle may be disposed at various positions such as a vehicle's center fascia, a driver's seat-side dashboard, a center console, a door-side armrest, and the like besides the steering wheel. Various designs and implementations are made along with an increase in the demand for emotional quality for a vehicle is increased, and a conventional vehicle switch knob forms a simple light output structure when lighting is turned on.

However, recently, owing to the expansion of functions and needs, multicolored light output elements such as ambient light are further provided, leading to an increased demand for lighting of the switch with various color optical outputs.

FIGS. 1 and 2 illustrate the optical paths of lights with different colors emitted from multicolored light sources, which are irradiated onto a single icon 2a in a conventional switch according to the prior art. In other words, icons 2a and 2b are disposed on one surface of a switch knob 2 of the switch 1, and a light source 4 (4a, 4b, and 4c) is disposed on one surface of a substrate 3 disposed within the switch knob. Lights emitted from the light sources 4a and 4b as light sources of different colors may be simultaneously irradiated onto the single icon 2a. In this case, a beam of light emitted from the light source 4a denoted by reference numeral 4a and irradiated onto an area A indicated by a double dotted line in terms of the positional characteristic of the icon 2a forms a straight path, but the beams Rb1 and Rb2 of lights emitted from the light source 4b indicated by the reference numeral 4b and irradiated onto the icon 2a in the area A do not achieve uniformity of light due to different optical path lengths 11 and 12.

In particular, the conventional switch entails a problem in that when various colors are assigned to the switch lighting, a plurality of light sources are arranged, and in this case, the beams of light emitted from respective different colored light sources through a display unit of the switch knob side produce a spotted color pattern, or a bias towards a specific color, which does not meet emotional quality desired by drivers or passengers.

### DISCLOSURE OF INVENTION

### Technical Problem

Accordingly, the present invention has been made to solve the above-mentioned problems occurring in the prior art, and it is an object of the present invention to provide a switch device for a vehicle, which has a structure that ensures the uniformity of light output to improve emotional quality desired by drivers or passengers.

### Technical Solution

To achieve the above object, the present invention provides a switch device (10) for a vehicle, including: a switch housing 100 fixedly disposed in the vehicle; a switch knob (200) disposed on the switch housing (100) so as to be manipulatable by a user, and including knob icons (201, 202) disposed on one surface thereof; a switch unit (300) operated by the user's manipulation of the switch knob (200) and configured to generate a changed electrical signal; and a light source unit (500) disposed within the switch housing (100) and configured to output and transmit light generated therefrom to the switch knob (200), herein the light source unit (500) comprises a plurality of knob icon light sources (510; 510a, 510b) configured to enable beams of light emitted therefrom to be simultaneously irradiated onto one of the knob icons (201, 202), and herein the switch knob (200) comprises, at least partially, a light control region part (230) having a difference in thickness between the inner and outer surfaces of the switch knob (200).

In the switch device for a vehicle, the light control region part (230) may include a concave-recess structure having a thickness between the inner and outer surfaces of the switch knob (200), which is smaller than that in a remaining region other than the light control region part (230) of the switch knob (200).

In the switch device for a vehicle, the light control region part 230 may include: a light control region outer line part (235) formed on the inner surface of the switch knob (200) and configured to capture the knob icon light sources (510; 510a and 510b) when projected onto the switch substrate (400) on which the knob icon light sources (510; 510a and 510b) are disposed; and a light control region inner part (231) formed on the inner surface of the switch knob (200) and configured to be captured in a region where the light control region outer line part (235) is formed when projected onto the switch substrate (400) on which the knob icon light sources (510; 510a and 510b) are disposed, the light control region inner part (231) being the farthest away from the knob icon light sources (510; 510a and 510b).

In the switch device for a vehicle, the light control region part (230) may further include a light control region inclined part (233) disposed between the light control region outer line part (235) and the light control region inner part (231) to form an inclined surface.

In the switch device for a vehicle, the light control region part (230) may include a plurality of light control region part pixels (230a, 230b, 230c and 230d) having different distances from the knob icon light source (510; 510a and 510b).

In the switch device for a vehicle, at least one of the plurality of light control region part pixels 230a, 230b, 230c and 230d may include a different surface morphology from the others.

In the switch device for a vehicle, a line segment tangent to at least one surface of the plurality of light control region part pixels (230a, 230b, 230c, and 230d) and a line segment tangent to at least another surface of the plurality of control light region part pixels (230a, 230b, 230c, and 230d) may intersect each other.

In the switch device for a vehicle, the light control region part (230) may include a block structure disposed on the inner bottom surface of the switch knob (200) to be oriented toward the light source unit (500).

In the switch device for a vehicle, the light control region part (230) may include a plurality of light control region part pixels (230a, 230b, 230c and 230d) having different distances from the knob icon light source (510; 510a and 510b).

In the switch device for a vehicle, at least one of the plurality of light control region part pixels 230a, 230b, 230c and 230d may include a different surface morphology from the others.

In the switch device (10) for a vehicle, a line segment tangent to at least one surface of the plurality of light control region part pixels (230a, 230b, 230c, and 230d) and a line segment tangent to at least another surface of the plurality of light control region part pixels (230a, 230b, 230c, and 230d) may intersect each other.

In the switch device for a vehicle, at least one of the plurality of light control region part pixels (230a, 230b, 230c and 230d) may further include a plurality of subdivided light control region part pixel sub-parts (231d, 233d and 235d).

In the switch device for a vehicle, the plurality of light control region part pixel sub-parts may include the same size.

In the switch device for a vehicle, the the size of any one of the plurality of light control region part pixel sub-parts may be different from that of any other light control region part pixel sub-part.

In the switch device for a vehicle, the plurality of light control region part pixels 230a, 230b, 230c and 230d may include a transparent material.

In the switch device for a vehicle, at least one of the plurality of light control region part pixels (230a, 230b, 230c and 230d) may include an opaque material.

In the switch device for a vehicle, the plurality of light control region part pixels (230a, 230b, 230c and 230d) may be integrally formed on the inner surface of the switch knob (200).

In the switch device for a vehicle, the plurality of light control region part pixels (230a, 230b, 230c and 230d) is formed to be attachable to the inner surface of the switch knob (200).

### Advantageous Effects

The switch device for a vehicle according to the present invention as constructed above has the following advantageous effects.

First, the switch device for a vehicle according to the present invention can enhance the uniformity of light output for each light output when the beams of light emitted from multicolored light sources exit the icons of the switch knob, thereby preventing the occurrence of stains or the like due to color bias, and thus the deterioration of the emotional quality.

Second, the switch device for a vehicle according to the present invention can enhance the uniformity of light output for each light output when the beams of light emitted from multicolored light sources exit the icons of the switch knob, thereby preventing the occurrence of stains or the like due to color bias, and thus the deterioration of the emotional quality. Thus, the inventive vehicle switch device can be applied to various product groups by increasing the manufacturing variation through various modifications such as a concave-recess structure, a pixel-like structure, and a detachable pixel-like structure.

While the present invention has been described in connection with the exemplary embodiments illustrated in the drawings, they are merely illustrative and the invention is not limited to these embodiments. It will be appreciated by a person having an ordinary skill in the art that various equivalent modifications and variations of the embodiments can be made without departing from the spirit and scope of the present invention. Therefore, the true technical scope of the present invention should be defined by the technical sprit of the appended claims.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic partial cross-sectional view illustrating a conventional switch according to the prior art;

FIG. 2 is a partial enlarged cross-sectional view of an area A of FIG. 1;

FIG. 3 is a schematic top perspective view illustrating a switch device for a vehicle according to an embodiment of the present invention;

FIG. 4 is a schematic exploded top perspective view illustrating a switch device for a vehicle according to an embodiment of the present invention;

FIG. 5 is a schematic bottom perspective view illustrating a switch knob of a switch device for a vehicle according to an embodiment of the present invention;

FIG. 6 is a schematic cross-sectional view taken along the line A-A in FIG. 5;

FIG. 7 is a schematic top perspective view illustrating a light source unit of a switch device for a vehicle according to an embodiment of the present invention;

FIG. 8 is a schematic partial side cross-sectional view illustrating a switch knob and a light source unit of a switch device for a vehicle according to an embodiment of the present invention;

FIG. 9 is a schematic partial perspective view illustrating one example of light control region part pixels of a switch device for a vehicle according to an embodiment of the present invention;

FIGS. 10 to 12 are top plan and side cross-sectional views illustrating one example of light control region part pixels of a switch device for a vehicle according to an embodiment of the present invention;

FIG. 13 is a schematic partial perspective view illustrating a state of one example of light control region part pixels of a switch device for a vehicle according to an embodiment of the present invention;

FIGS. 14 and 15 illustrate a schematic partial bottom view of a switch knob formed with light control region part pixels of a switch device for a vehicle according to an embodiment of the present invention and a side cross-sectional view taken along the line D-D in FIG. 14; and

FIG. 16 is a schematic bottom view illustrating a switch knob of a modification of light control region part pixels and light control region part pixels according to an embodiment of the present invention.

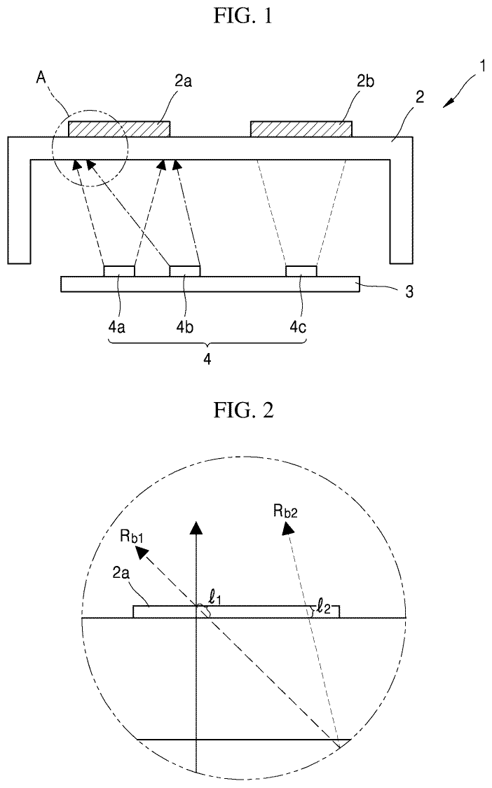

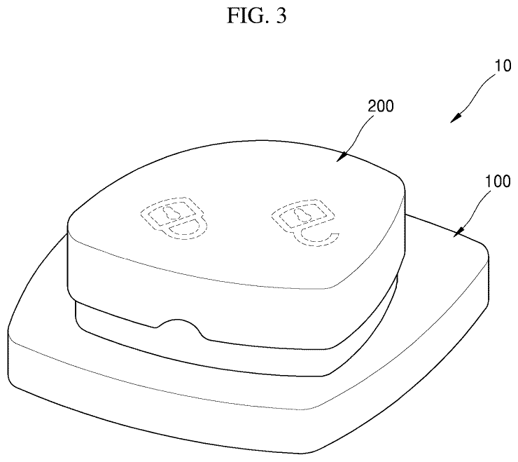

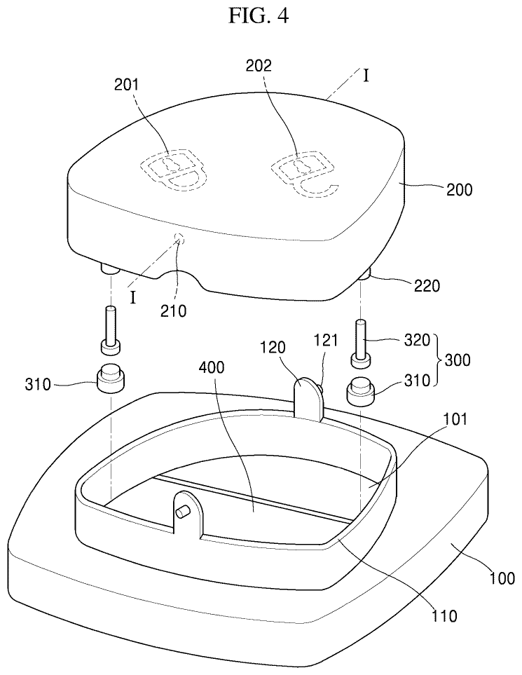

### BEST MODE FOR CARRYING OUT THE INVENTION

Now, a switch device for a vehicle according to the present invention will be described hereinafter in detail with reference to the accompanying drawings.

A switch device 10 for a vehicle according to an embodiment of the present invention is composed of switch elements mounted on the vehicle. Various arrangement positions may be selected depending on design specifications such as being arranged on various constituent elements such as a steering wheel, a dashboard, an inter fascia or a vehicle door side, an overhead lamp side or a center console, or the like of the vehicle.

The switch device 10 for a vehicle according to an embodiment of the present invention includes a switch housing 100, a switch knob 200, a switch unit 300, and a light source unit 500.

The switch housing 100 is fixedly disposed in the vehicle. The switch housing 100 is fixedly disposed on each of the above-described constituent elements of the vehicle. The switch housing 100 has an inner space to allow other constituent elements to be disposed therein. The switch housing 100 has a housing opening 101 formed on one surface thereof to allow the inner space and the outside of the switch housing 100 to fluidically communicate with each other so that a predetermined switching operation may be implemented through the housing opening 101. A housing rib 110 is formed on the outer circumference of the housing opening 101, and a pair of opposed housing knob mounting parts 120 are disposed on the housing rib 101.

The housing knob mounting parts 120 are formed extending from the housing rib 110 toward the switch knob 200, and a knob mounting protrusion 121 is formed on each of the housing knob mounting part 120.

The switch knob 200 is movably mounted on an upper end of the switch housing 100. In some cases, the switch unit 300 of the present invention may be implemented as a touch switch for performing a touch operation through contact, but in the present invention, a description will be made centering on the case where the switch unit 300 is implemented as a switch for performing a physical movement by a contact operation. Accordingly, the switch knob 200 of the present invention is hingeably disposed on the switch housing 100.

As described above, the housing knob mounting parts 120 are formed extending from the housing rib 110 toward the switch knob 200, and the knob mounting protrusion 121 is formed on each of the housing knob mounting portions 120. A knob mounting protrusion corresponding part 210 is formed on the line I-I of the switch knob 200 to correspond to each of the knob mounting protrusions 121 as described later in the switch knob 200. In this case, the knob mounting protrusion 121 and the knob mounting protrusion corresponding part 210 form an engagement structure in which they are rotatable relative to each other.

The switch knob 200 is disposed on the switch housing 100 so as to be manipulatable by a user. As described above, the switch knob (200) is disposed to be movable by a seesaw operation. The switch knob 200 includes knob icons 201 and 202 disposed on one surface thereof. The knob icons 201 and 202 may be formed by a laser etching method and may be formed in various manners depending on design specifications. In addition, the beam of light emitted from the light source unit 500 and exiting the knob icons 201 and 202 may be outputted to the outside of the switch knob 200.

The switch unit 300 according to an embodiment of the present invention is operated by the user's manipulation of the switch knob 200 to generate a changed electrical signal. The switch unit 300 includes a switch 310 and a switch plunger 320. The switch 310 is disposed on a switch substrate 400, and in this embodiment, the switch 310 is implemented in the form of a push switch that forms a physical change through a pressing operation. The switch plunger 320 is disposed on an upper side of the switch 310, and includes a plunger shaft 321 and a plunger base 323. The plunger shaft 321 is formed as a rectangular rod, and the plunger base 323 is disposed at a lower end of the plunger shaft 321. The plunger base 323 has an area larger than that of the plunger shaft 321 to increase a contact area with the switch 310 to form a stable pressing structure.

An end portion of the plunger shaft 321 forms a state of being in contact with a knob moving part 220 so that the knob moving part 220 presses the plunger shaft 321 when the switch knob 200 is moved by the seesaw operation, and the plunger base 323 at the lower end of the plunger shaft 321 presses the switch 310 to generate a change in the electrical signal.

As described above, the beams of light exiting the switch knob 200 and outputted to the outside are emitted from the light source unit 500. The light source unit 500 is disposed within the switch housing 100 to output and transmit light generated therefrom to the switch knob 200. The switch substrate 400 is disposed within the switch housing 100, and includes the light source unit 500 on one surface thereof.

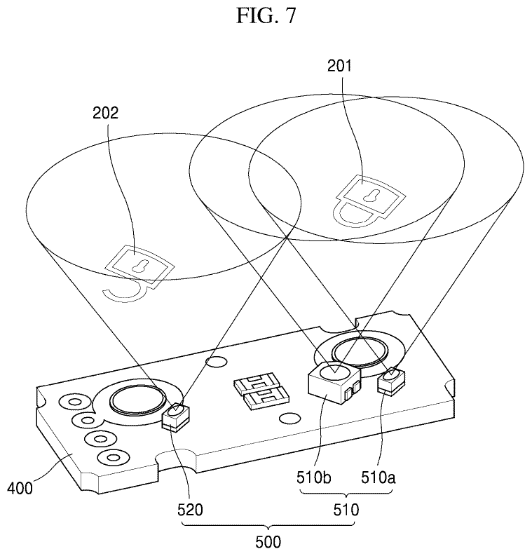

The light source unit 500 includes a plurality of knob icon light sources 510 (510a and 510b), and 520, and the beams of light emitted from the knob icon light sources 510 (510a and 510b) and 520 exit the knob icons 201 and 202 on one surface of the switch knob 200 toward the outside. In this case, the beams of light emitted from two or more knob icon light sources 510 (510a and 510b) of the plurality of knob icon light sources 510 (510a and 510b) and 520 of the light source unit 500 of the present invention exit at least one knob icon 201 or 202 toward the outside. Two beams of light may be irradiated onto the knob icon 201 simultaneously. The beam of light emitted from the knob icon light source 520 may be separately irradiated onto the knob icon 201. As shown in FIG. 7, the two beams of light may be simultaneously irradiated onto the knob icon 201, and may be overlapped with each other to exit the knob icon 201.

In this case, the switch knob 200 includes, at least partially, a light control region part 230. The light control region part 230 has a difference in thickness between the inner and outer surfaces of the switch knob 200.

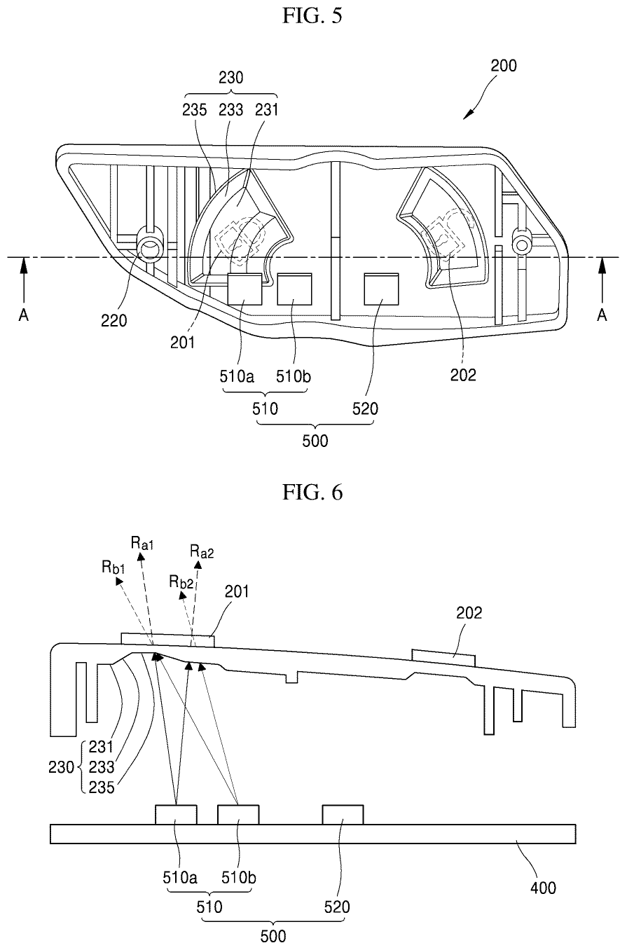

As shown in FIGS. 5 and 6, the light control region part 230 includes a concave-recess structure having a thickness between the inner and outer surfaces of the switch knob 200, which is smaller than that in a remaining region other than the light control region part 230 of the switch knob 200. More specifically, the light control region part 230 includes a light control region outer line part 235 and a light control region inner part 231.

The light control region outer line part 235 is formed on the inner surface of the switch knob 200 and captures the knob icon light sources 510 (510a and 510b) when projected onto the switch substrate 400 on which the knob icon light sources 510 (510a and 510b) are disposed. The light control region inner part 231 is formed on the inner surface of the switch knob 200 and is captured in a region where the light control region outer line part 235 is formed when projected onto the switch substrate 400 on which the knob icon light sources 510 (510a and 510b) are disposed. The light control region inner part (231) is the farthest away from the knob icon light sources 510 (510a and 510b).

In this case, the light control region part 230 further includes a light control region inclined part 233. The light control region inclined part 233 is disposed between the light control region outer line part 235 and the light control region inner part (231) to form an inclined surface. The beams of light emitted from the knob icon light source 510 (510a and 510b) may be accommodated in the light control region inclined part 233 through the inclined concave-recess structure.

As such, in view of different irradiation characteristics, for example, when the beams of light with the same color exit the knob icon 201 through a structure having a thickness difference, a difference in uniformity of light exiting the knob icon light sources 510 (510a and 510b) may be minimized by reducing a difference in the optical path through the reduction of the thickness of the switch knob 200 through which the knob icon light sources 510 (510a and 510b) pass.

Meanwhile, although a method of minimizing a difference in uniformity of light emitted from the knob icon light sources 510 (510a and 510b) through the reduction in the thickness of the switch knob 200 has been adopted in the above embodiment, the present invention is not limited thereto, and various modifications may be made in a range of minimizing a difference in uniformity of light outputted to the knob icon 201 of the switch knob 200 from the knob icon light sources 510 (510 a and 510b.

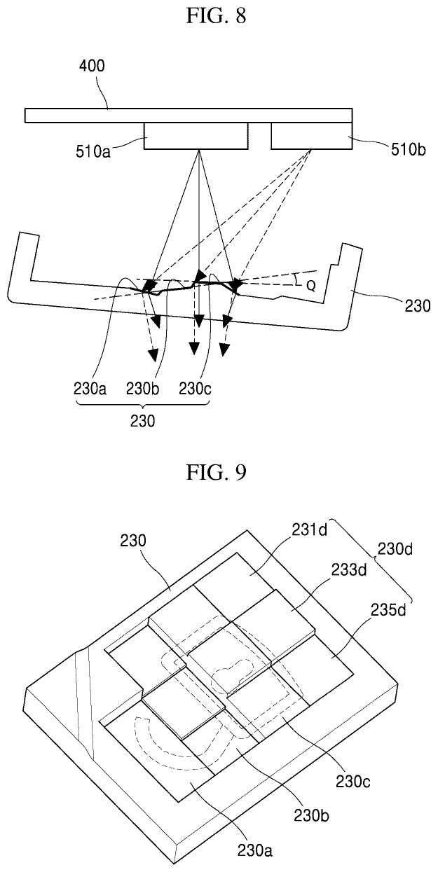

In other words, as shown in FIGS. 8 to 15, the light control region part 230 may include a plurality of light control region part pixels 230a, 230b, 230c and 230d. Each of the plurality of light control region part pixels 230a, 230b, 230c and 230d may further include a plurality of subdivided light control region part pixel sub-parts 231d, 233d and 235d. That is, by virtue of a configuration in which at least one of the plurality of light control region part pixels 230a, 230b, 230c and 230d according to an embodiment of the present invention further includes a plurality of subdivided light control region part pixel sub-parts 231d, 233d and 235d, the present invention may adopt a configuration for enhancing individual condition satisfaction, such as improving irradiation direction or uniformity of light depending on various design specifications for each product.

The plurality of light control region part pixels 230a, 230b, 230c and 230d have different distances from the knob icon light source (510; 510a and 510b). The light control region part 230 is a region where the knob icon 201 of the switch knob 200 is formed, and is formed on the inner surface of the switch knob 200, which is oriented toward the knob icon light sources 510 (510a and 510b). The light control region part 230 is arranged to be divided into the plurality of light control region part pixels 230a, 230b, 230c and 230d. in this case, The light control region part 230 is configured such that the distances between the surface of each of the light control region part pixels 230a, 230b, 230c and 230d, more specifically the surfaces of the plurality of light control region part pixels 230a, 230b, 230c and 230d and the plurality of knob icon light sources 510 (510a and 510b) are set to be different from each other, so that the difference in the optical path of light according to the and ultimately, light sources can be mitigated, the difference in the uniformity of light exiting the knob icon 201 can be minimized.

In addition, at least one of the plurality of light control region part pixels 230a, 230b, 230c and 230d of the present invention has a structure with a different surface morphology from the others. In other words, in addition to a structure in which the distances between the surfaces of the plurality of light control region part pixels 230a, 230b, 230c and 230d and the plurality of knob icon light sources 510 (510a and 510b) are set to be different from each other to mitigate the difference in the optical path of light according to the light sources, the difference in the uniformity of light exiting the knob icon 201 can be minimized by varying the light incident angles of the surfaces with different surface morphologies and different surface inclinations of the plurality of light control region part pixels 230a, 230b, 230c and 230d.

More specifically, as shown in FIG. 8, the light control region part 230 may adopt a structure in which a line segment tangent to at least one surface of the plurality of light control region part pixels 230a, 230b, 230c, and 230d and a line segment tangent to at least another surface of the plurality of light control region part pixels 230a, 230b, 230c, and 230d may intersect each other.

As shown in FIG. 8, the line segments tangent to the surfaces of the respective light control region part pixels 230b and 230c are formed on the respective light control region part pixels 230b and 230c of the light control region part pixels 230a, 230b, 230c, and 230d, respectively, and the line segments tangent to the surfaces of the light control region part pixels 230b and 230c form an angle denoted by reference symbol Q therebetween and intersect each other.

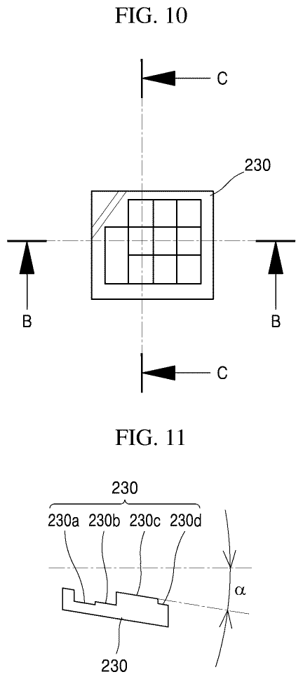

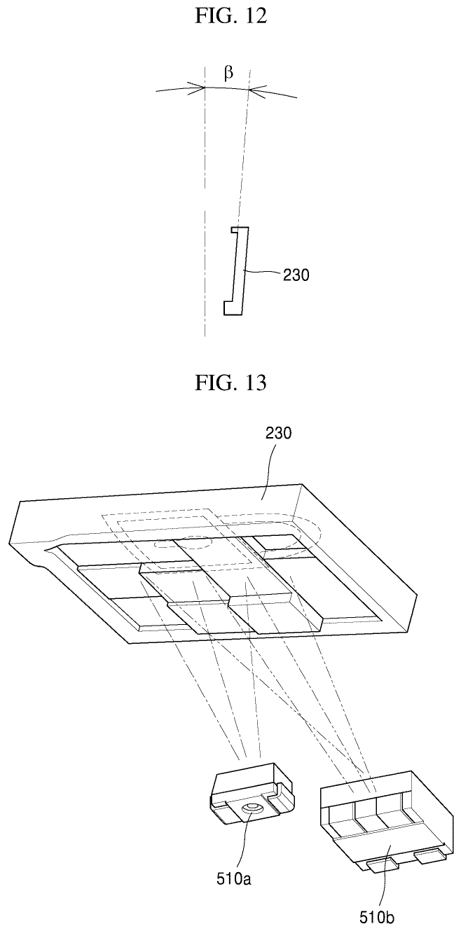

In addition, each of the light control region part pixels may be implemented in the form of a matrix-shaped pixel. FIGS. 9 and 10 illustrate the top plan views of the light control region part pixels 230a, 230b, 230c and 230d, and FIGS. 11 and 12 illustrate cross-sectional views taken along the lines B-B and C-C in FIG. 10. In the drawings, one surface of each of the plurality of light control region part pixels 230a, 230b, 230c and 230d may have a structure for changing a distance spaced apart from the light sources by identically maintaining respective surface angle states grouped or individualized for the plurality of light control region part pixels 230a, 230b, 230c and 230d, but varying the heights of the light control region part pixels 230a, 230b, 230c and 230d through the formation of a three-dimensional concavo-convex structure with a surface inclination of an angle α in FIG. 11 and a surface inclination of an angle β in FIG. 12.

Besides, the plurality of light control region part pixel sub-parts may have various selected sizes. In other words, the plurality of light control region part pixel sub-parts may have the same size. More specifically, the plurality of light control region part pixel sub-parts may have a configuration in which the external uniformity thereof is ensured by having the same size when projected on the outer surface of the switch knob 200 on which the knob icons 201 and 202 are disposed, and a configuration in which the size of any one of the plurality of light control region part pixel sub-parts is different from that of any other light control region part pixel sub-part so as to meet various changes in the irradiation angle between the switch knob and the light source unit along with the improvement of a degree of freedom of design. As such, the plurality of light control region part pixel sub-parts may be modified in various manners.

Although the sizes of the plurality of light control region part pixel sub-parts is described based on the size of a region projected onto a surface parallel to the outer surface of the switch knob 200 on which the knob icons 201 and 202 are formed in this embodiment, this is merely an example. The plurality of light control region part pixel sub-parts may be modified in various manner depending on design specifications, such as being formed on a plane parallel to the inner bottom surface of the switch knob or a plane parallel to the rear surfaces of separate mountings when the plurality of light control region part pixel sub-parts is formed as the separate mountings in some cases.

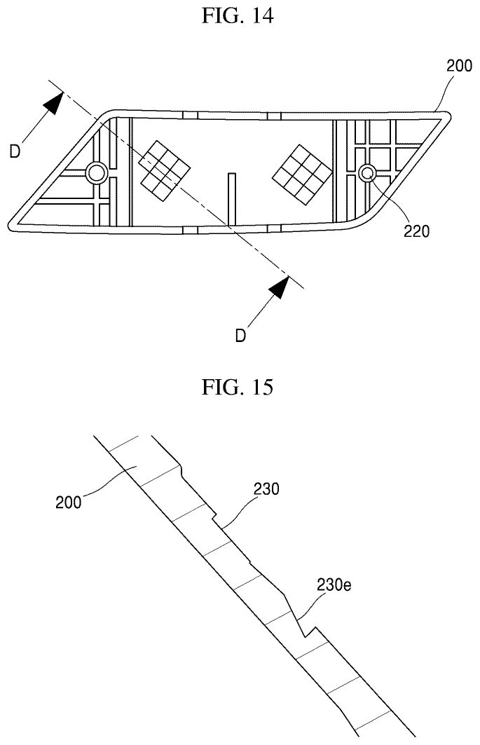

FIG. 13 illustrates a schematic bottom perspective view of the light control region part pixels of FIG. 9 and the knob icon light sources. As shown in FIGS. 14 and 15, the light control region part pixels may be configured variously, such as being integrally formed on the switch knob.

By virtue of this configuration, at least two of the plurality of light control region part pixels 230a, 230b, 230c and 230d are set to vary the angles of the beams of light incident through the surfaces thereof, that is, light incident angles, so that luminosity bias due to a difference in the optical path difference can be distributed to secure the uniformity of light through the knob icon 201, leading to an increase in the visibility of manipulation and an improvement in the emotional quality of the light through the uniform exit of light by the knob icon 201 of the switch knob 200 for a user of the vehicle such as a driver.

In the meantime, the light control region part 230 of the present invention may have various configurations. Although a description has been made centering on a configuration in which the light control region part 230 has a concave-recess structure or a regionalized structure of pixels formed on a bottom surface of the switch knob 200 in the previous embodiment, the present invention is not limited thereto, and the light control region part 230 may have a configuration in which it is provided as a separate constituent element to be fixedly disposed on the switch knob 200.

In other words, the light control region part 230 may be formed as a simple concave-recess structure or a pixel-like structure. In addition, such a concave-recess or pixel-like structure may have a configuration in which it is formed as a separate constituent element to be attached on the inner surface of the switch knob 200.

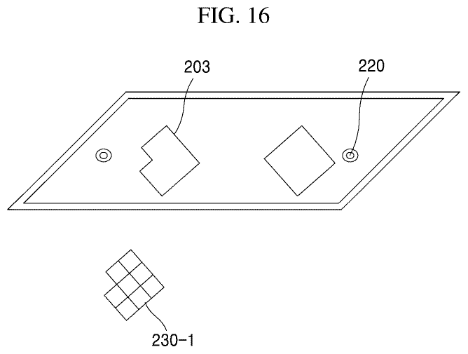

That is, the plurality of light control region part pixels 230a, 230b, 230c and 230d may be integrally formed on the inner surface of the switch knob 200, and the plurality of light control region part pixels 230a, 230b, 230c and 230d may be formed to be attachable to the inner surface of the switch knob 200. As shown in FIG. 16, the light control region part 230 may have a block structure disposed on the inner bottom surface of the switch knob 200 to be oriented toward the light source unit 500, and a switch knob region mounting unit 203 may be formed inside the switch knob 200, so that the light control region part 230 may be fixedly mounted on the switch knob region mounting unit 203.

In this case, the light control region part 230 may have a structure in which it includes a plurality of light control region part pixels 230a, 230b, 230c and 230d having different distances from the knob icon light source 510; 510a and 510b, or may, selectively or simultaneously, have a structure in which at least one of the plurality of light control region part pixels 230a, 230b, 230c and 230d may include a different surface morphology from the others. This is the same as the case where the light control region part 230 is directly formed on the inner surface of the switch knob 200.

In this case, a line segment tangent to at least one surface of the plurality of light control region part pixels 230a, 230b, 230c, and 230d and a line segment tangent to at least another surface of the plurality of light control region part pixels 230a, 230b, 230c, and 230d may intersect each other. In other words, a substantially parallel state is formed between the light source unit 500 and the bottom surface of the switch knob 200, but a line segment tangent to at least one surface of the light control region part pixels 230a, 230b, 230c and 230d, which are pixelated into a plurality of discrete regions, and a line segment tangent to at least another surface of the plurality of light control region part pixels 230a, 230b, 230c, and 230d intersect each other without being parallel to each other, so that when projected onto a plane perpendicular to a rotary axis of the switch knob 200, the both tangent segment lines can intersect each other.

Moreover, the plurality of light control region part pixels 230a, 230b, 230c and 230d may include a transparent material, and at least one of the plurality of light control region part pixels 230a, 230b, 230c and 230d may include an opaque material. As such, the light control region part pixels 230a, 230b, 230c and 230d may be selected in various manners based on a degree of irradiation of light and a degree of demand for emotional quality depending on design specifications.

By virtue of such a separate mounting structure or the like, the variations of a switch device for various kinds of vehicles may be diversified to modifiably mount only the light control region part 230, which is changed for each vehicle, to the universal manufacturing structure of the switch knob, thereby enabling various product combinations to reduce the manufacturing costs.

While the present invention has been described in connection with the exemplary embodiments illustrated in the drawings, they are merely illustrative and the invention is not limited to these embodiments. It will be appreciated by a person having an ordinary skill in the art that various equivalent modifications and variations of the embodiments can be made without departing from the spirit and scope of the present invention. Therefore, the scope of protection of the present invention should be interpreted by the appended claims, and it should be interpreted that all technical spirits within the scope equivalent to the claims fall within the scope of the present invention.

### INDUSTRIAL APPLICABILITY

Although the present invention has been described in relation to a switch for a vehicle, for example, a switch for a vehicle used for a window lock, a door lock or the like, it may be applied to a variety of infotainment switches including an audio switch in the vehicle, and to various switches for performing light irradiation, such as switches for industrial and household purposes, even in the case of the switches other than the switch for the vehicle.

1. A switch device (10) for a vehicle, comprising:
a switch housing (100) fixedly disposed in the vehicle;
a switch knob (200) disposed on the switch housing (100) so as to be manipulatable by a user, and including knob icons (201, 202) disposed on one surface thereof;
a switch unit (300) operated by the user's manipulation of the switch knob (200) and configured to generate a changed electrical signal; and
a light source unit (500) disposed within the switch housing (100) and configured to output and transmit light generated therefrom to the switch knob (200),
wherein the light source unit (500) comprises a plurality of knob icon light sources (510; 510a, 510b) configured to enable beams of light emitted therefrom to be simultaneously irradiated onto one of the knob icons (201, 202), and
wherein the switch knob (200) comprises, at least partially, a light control region part (230) having a difference in thickness between the inner and outer surfaces of the switch knob (200).

2. The switch device (10) for a vehicle according to claim 1, wherein the light control region part (230) comprises a concave-recess structure having a thickness between the inner and outer surfaces of the switch knob (200), which is smaller than that in a remaining region other than the light control region part (230) of the switch knob (200).

3. The switch device (10) for a vehicle according to claim 2, wherein the light control region part (230) comprises:
a light control region outer line part (235) formed on the inner surface of the switch knob (200) and configured to capture the knob icon light sources (510; 510a and 510b) when projected onto the switch substrate (400) on which the knob icon light sources (510; 510a and 510b) are disposed; and
a light control region inner part (231) formed on the inner surface of the switch knob (200) and configured to be captured in a region where the light control region outer line part (235) is formed when projected onto the switch substrate (400) on which the knob icon light sources (510; 510a and 510b) are disposed, the light control region inner part (231) being the farthest away from the knob icon light sources (510; 510a and 510b).

4. The switch device (10) for a vehicle according to claim 3, wherein the light control region part (230) further comprises a light control region inclined part (233) disposed between the light control region outer line part (235) and the light control region inner part (231) to form an inclined surface.

5. The switch device (10) for a vehicle according to claim 1, wherein the light control region part (230) comprises a plurality of light control region part pixels (230a, 230b, 230c and 230d) having different distances from the knob icon light source (510; 510a and 510b).

6. The switch device (10) for a vehicle according to claim 5, wherein at least one of the plurality of light control region part pixels (230a, 230b, 230c and 230d) comprises a different surface morphology from the others.

7. The switch device (10) for a vehicle according to claim 6, wherein a line segment tangent to at least one surface of the plurality of light control region part pixels (230a, 230b, 230c, and 230d) and a line segment tangent to at least another surface of the plurality of light control region part pixels (230a, 230b, 230c, and 230d) intersect each other.

8. The switch device (10) for a vehicle according to claim 1, wherein the light control region part (230) comprises a block structure disposed on the inner bottom surface of the switch knob (200) to be oriented toward the light source unit (500).

9. The switch device (10) for a vehicle according to claim 8, wherein the light control region part (230) comprises a plurality of light control region part pixels (230a, 230b, 230c and 230d) having different distances from the knob icon light source (510; 510a and 510b).

10. The switch device (10) for a vehicle according to claim 9, wherein at least one of the plurality of light control region part pixels (230a, 230b, 230c and 230d) comprises a different surface morphology from the others.

11. The switch device (10) for a vehicle according to claim 10, wherein a line segment tangent to at least one surface of the plurality of light control region part pixels (230a, 230b, 230c, and 230d) and a line segment tangent to at least another surface of the plurality of light control region part pixels (230a, 230b, 230c, and 230d) intersect each other.

12. The switch device (10) for a vehicle according to claim 9, wherein at least one of the plurality of light control region part pixels (230a, 230b, 230c and 230d) further comprises a plurality of subdivided light control region part pixel sub-parts (231d, 233d and 235d).

13. The switch device (10) for a vehicle according to claim 12, wherein the plurality of light control region part pixel sub-parts comprises the same size.

14. The switch device (10) for a vehicle according to claim 13, wherein the size of any one of the plurality of light control region part pixel sub-parts is different from that of any other light control region part pixel sub-part.

15. The switch device (10) for a vehicle according to claim 5, wherein the plurality of light control region part pixels (230a, 230b, 230c and 230d) comprises a transparent material.

16. The switch device (10) for a vehicle according to claim 5, wherein at least one of the plurality of light control region part pixels (230a, 230b, 230c and 230d) comprises an opaque material.

17. The switch device (10) for a vehicle according to claim 5, wherein the plurality of light control region part pixels (230a, 230b, 230c and 230d) is integrally formed on the inner surface of the switch knob (200).

18. The switch device (10) for a vehicle according to claim 5, wherein the plurality of light control region part pixels (230a, 230b, 230c and 230d) is formed to be attachable to the inner surface of the switch knob (200).
